(19) United States
(12) Patent Application Publication
(10) Pub. No.: US 2003/0222764 A1
(43) Pub. Date: Dec. 4, 2003

(54) Remote message posting system

(76) Inventor: Adam G. Slote, Tiburon, CA (US)

Correspondence Address: Leo Stanger, Stanger & Dreyfus, P.C., 382 Springfield Ave., P.O. Box 1455, Summit, NJ, 07901, US

(21) Appl. No.: 10/159,774

(22) Filed: May 31, 2002

(51) Int. Cl. H04Q 7/00

(52) U.S. Cl. 340/7.55; 340/7.1

(57) ABSTRACT

A user uses a computer, handheld computer, Web browser wireless phone, two-way pager, traditional telephone or other communication device to cause a message to be displayed for one or more known or unknown third parties on the display of a wireless messaging device that is attached to a door, wall, object or structure in a remote location.

### FIELD OF THE INVENTION

This invention is a method of displaying messages in remote locations using a wireless messaging device with a visual display that can be affixed to doors, walls, refrigerators and other locations where people commonly affix notes for others to read. Users cause a message to be displayed on the device by addressing the device through a global computer network and wireless networks.

### BACKGOUND OF THE INVENTION

Presently, a person who desires to leave a message for other persons must write a note on paper and affix the paper to a location where it is likely to be seen. This requires that the person leaving the message travel to the location that the message is to be posted.

Travel to the location where the message is to be posted is not always possible or convenient.

For example, a homeowner driving home to meet a cable television installer or other utility company employee may become stuck in traffic and miss the appointment. A note on the door for the installer explaining the delay might allow the installer to take a short break and keep the appointment.

For another example, the owner of a retail store becomes ill and cannot open her store in the morning. Although she would like to leave a note on the door for her customers, she is too ill to travel to the store to post the note.

An object of the invention is to overcome the difficulty of leaving a note in a remote location.

### SUMMARY OF EMBODIMENTS OF THE INVENTION

An embodiment of the invention involves a user using a computer and a global computer network (the Internet) to access a Web site where the user can enter or select text and/or graphics to be displayed on the display of a Wireless Message Device affixed to the location where the message is to be posted. The Wireless Messaging Device can be addressed only by a user who possesses a secret alpha-numeric password. An advantage being that device is useless to potential thieves.

Another embodiment involves the use of a telephone dial pad to enter an alpha-numeric message to be displayed as described above.

Another embodiment involves speaking into a telephone and the conversion of such speech into text by voice recognition software to enter an alpha-numeric message to be displayed as described above.

Another embodiment involves the use of a two-way pager, cellular telephone or other wireless computing or communications device to enter the message to be displayed, as described above.

Another embodiment uses any of the means described above to select pre-set messages to be displayed as described above.

These and other aspects of the invention are pointed out in the claims annexed to this specification and made a part hereof. Other objects and advantages of the invention will become evident from the following detailed description of preferred embodiments of the invention, when read in light of the following drawings.

### BRIEF DESCRIPTION OF THE DRAWINGS

FIG. 1 is a diagram illustrating the wireless messaging device that is a component of an embodiment of the invention.

FIG. 2 is a block diagram of the wireless messaging device that is a component of an embodiment of the invention.

FIG. 3 is a block diagram of an embodiment of the invention.

FIG. 4 is a flow chart of the process of FIG. 3.

### DETAILED DESCRIPTION OF PREFERRED EMBODIMENT

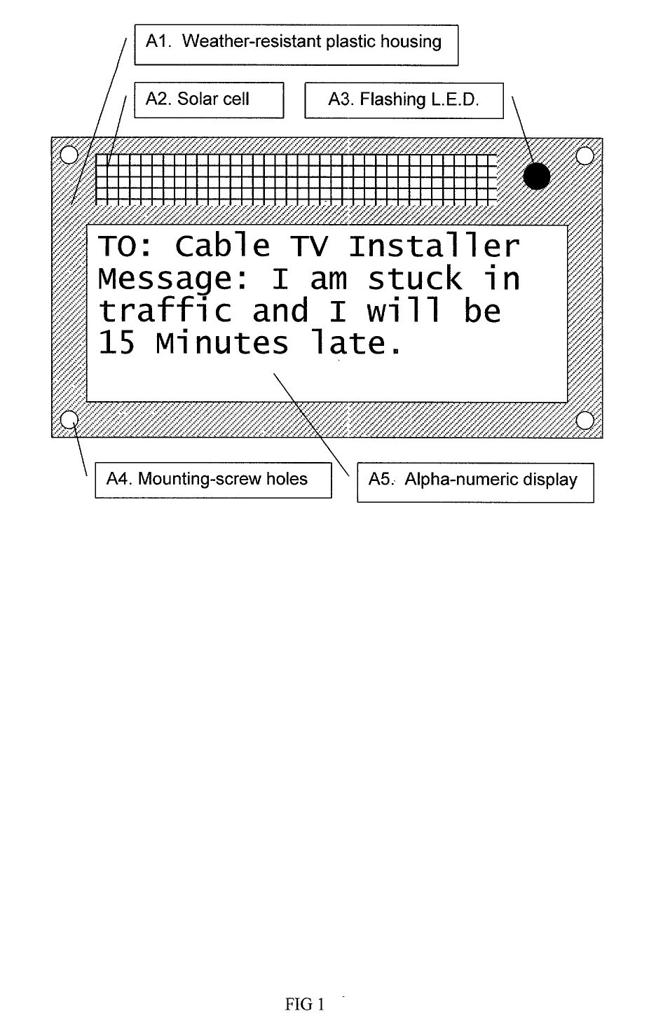

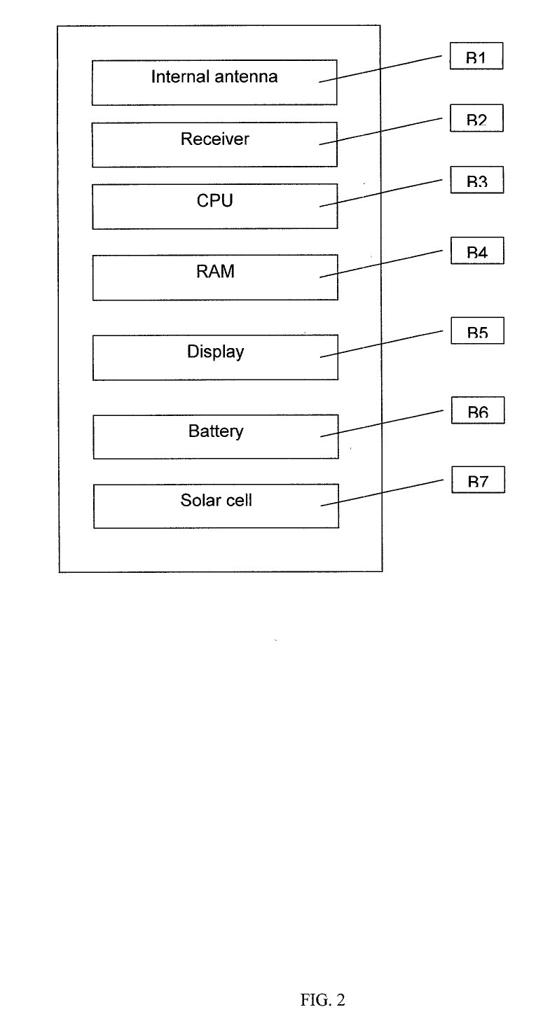

FIG. 1 is a diagram illustrating an embodiment of a component of the invention described herein as the Wireless Messaging Device. The compact device can be mounted on a door, wall or other locations where the user desires to leave messages. A1 is a weather resistant plastic housing. A2 is a solar cell used to charge the battery that powers the device. Alternatively, A2 can be used to power only the display (A5) and/or the flashing LED (A3) in order to conserve battery power used for the radio receiver (FIG. 2, B2) and CPU (FIG. 2, B3). A3 is an optional flashing LED used to attract attention to the device when a message is being displayed. A3 can be supplemented or replaced with an audible alarm such as a piezo-electric buzzer. A4 is a screw hole located at the corners of the device for mounting. The device can also be mounted with adhesive and/or magnetic materials on the back of the device. The device may also be hanged or attached to one or more suction cups so it can be seen through glass doors or windows. A5 is a liquid crystal display (L.C.D.) for displaying messages.

FIG. 2 is a block diagram of the Wireless Messaging Device that is a component of the invention. B1 is an internal radio antenna. B2 is a radio receiver. B3 is a CPU used for processing data received via the receiver and displaying messages on the LCD display (B5) for the time specified, or for a pre-determined time period. B4 is random access memory used by the CPU (B3) for data processing and storage. B5 is the alpha-numeric LCD display used for displaying the message. B5 may have backlighting for reading at night. B6 is a battery which may be rechargeable by the solar cell (B7) and which may be replaceable or non-replaceable. B7 is a solar cell used to charge the battery (B6) or to directly power any part of the device.

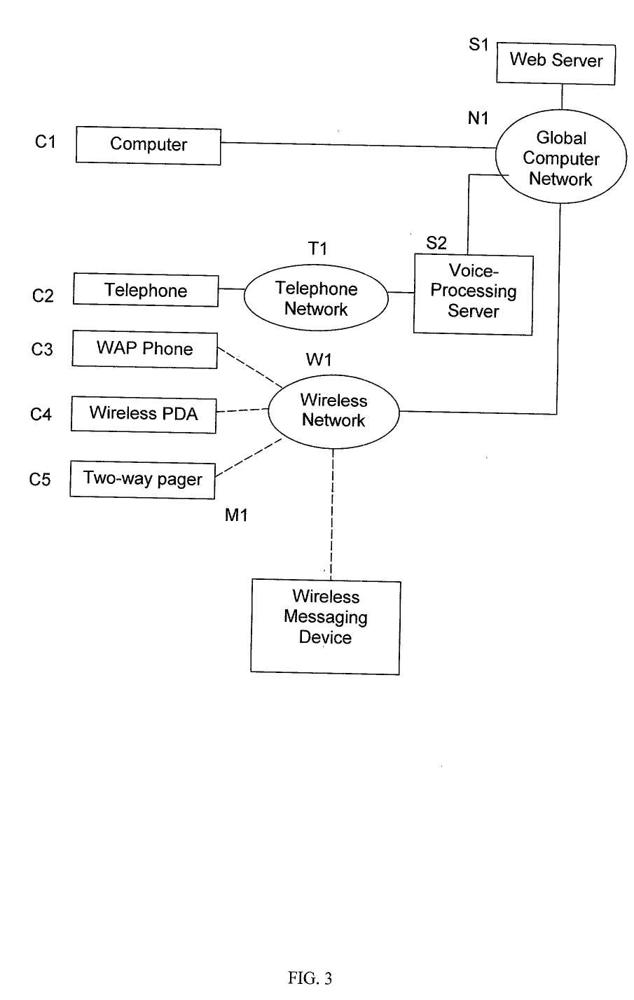

In FIG. 3, a user uses a computer (C1) to access a Web page hosted on a server computer (S1) via a global computer network (N1). Via C1, the user enters and/or selects text and/or graphics and options for controlling the display of a message via Wireless Messaging Device (M1). S1 sends data to M1 via a global computer network (N1) and a wireless network (W1).

FIG. 3 also illustrates a second embodiment of the invention where a user uses a wired or wireless telephone C2 to access a server computer with voice processing and/or touch tone processing software (S2) via a via a telephone network (T1). Via C2, the user enters and/or selects text and/or graphics and options for controlling the display of a message via Wireless Messaging Device (M1). S2 sends data to M1 via a global computer network (N1) and a wireless network (W1).

A third embodiment involves the use of a wireless phone (C3) with an internal Web browser to access a Web page hosted on a server computer (S1) via a wireless network (W1) and a global computer network (N1). The remaining steps are identical to those described above in the first embodiment.

A fourth embodiment involves the use of a wireless personal digital assistant (C3), such as a Palm VII. The remaining steps are identical to those described above in the third embodiment.

A fifth embodiment involves the use of a two-way pager (C4), such as a Rim Networks' Blackberry. The remaining steps are identical to those described above in the third embodiment.

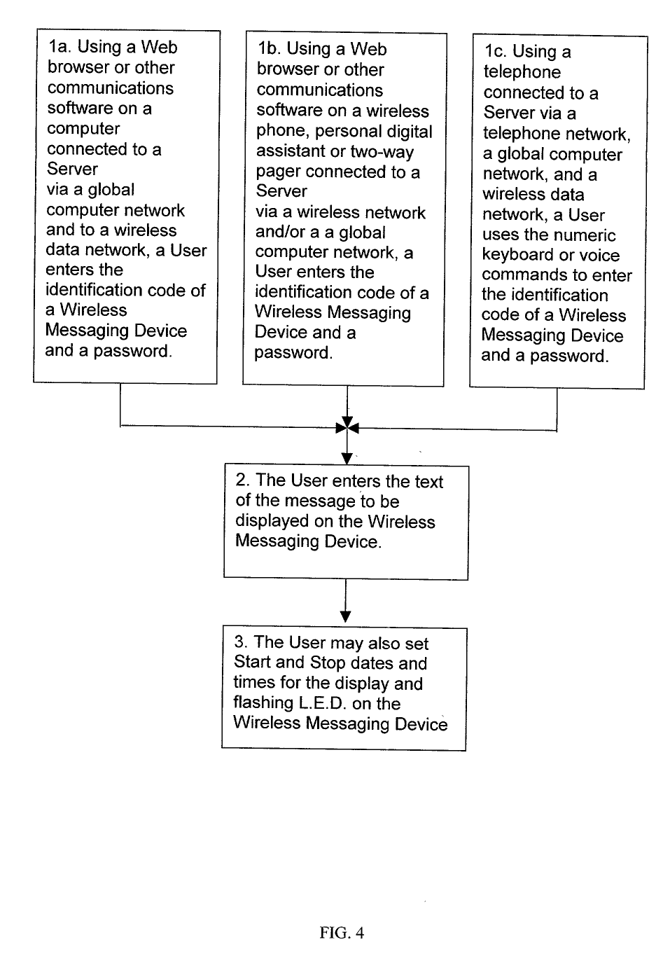

FIG. 4 is a flow chart illustrating the process of using the invention. In step 1a, a user uses a computer to connect to a Web server via a global computer network and enters the identification code of a Wireless Messaging Device and a password. Alternate Step 1b, illustrates the same activity using a Web browser or other communications software on a wireless phone, personal digital assistant or two-way pager. Alternate Step 1c, illustrates the same activity using a telephone connected to a telephone connected to a voice-processing and/or touch tone processing server.

In step 2, the user enters the text of the message to be displayed on the Wireless Messaging Device.

In step 3, the User may also set Start and Stop dates and times for the display of the message and flashing L.E.D. on the Wireless Messaging Device.

The embodiments offer a user the opportunity to quickly and easily post a message in a remote location without traveling to that location.

The invention is not limited to a system for displaying messages to individual viewers. The invention can also be used to control multiple signs that announce events and display directional arrows leading audiences through public and private buildings. Signs can be used to identify the frequently changing names of patients in hospital rooms and information about courses held in university classrooms. Signs can also be used for prices on the shelves of retail stores allowing retail store chains to quickly and easily update price and product information on the shelves of stores across the world.

While embodiments of the invention have been described in detail, it will be evident to those skilled in the art that the invention may be embodied otherwise without departing from its spirit and scope.

What is claimed is:

1. A wireless messaging device compromising:
(a) a radio receiver for receiving data via paging, cellular or other wireless data networks,
(b) a central processing unit for converting data received by the receiver into instructions into text or graphics to be displayed on a display screen,
(c) a display device for displaying text and/or graphics,
(d) a means for attaching said device to objects or structures.

2. A wireless messaging device as in claim 1 wherein the central processing unit in said device converts data received by the receiver into instructions for controlling said device.

3. A wireless messaging device as in claim 1 wherein the means for attaching said device to objects or structures compromises an adhesive backing material.

4. A wireless messaging device as in claim 1 wherein the means for attaching said device to objects or structures compromises a magnetic backing material.

5. A wireless messaging device as in claim 1 wherein the means for attaching said device to objects or structures compromises one or more holes, slots or notches for attaching hardware such as screws, tacks, nails or staples.

6. A wireless messaging device as in claim 1 wherein the means for attaching said device to objects or structures compromises one or more suction cups.

7. A wireless messaging device as in claim 1 wherein a solar cell is used to provide or supplement power to said device.

8. A wireless messaging device as in claim 1 wherein the device can be addressed only by a user with the correct identification code and/or password so as to make the device useless to potential thieves and deter theft.

9. A method for displaying a message in a remote location, comprising:
transmitting, using a computer or via a global computer network or a wireless network, a message to be displayed on a Wireless Messaging Device,
viewing, a message using a Wireless Messaging Device.

10. The method as claimed in claim 9 wherein the user uses a telephone to transmit a message via voice or touch-tone inputs to be interpreted by a server computer with voice processing and/or touch-tone processing software.

11. The method as claimed in claim 9 wherein the user uses a telephone to communicate a message to a human operator who types the message into a computer.

12. The method as claimed in claim 9 wherein the user uses a handheld wireless computing and/or communications device instead of a traditional computer.

13. The method as claimed in claims 9 through 13 wherein the user selects one or more pre-defined messages to be displayed.

14. The method as claimed in claim 9 wherein the user selects a start time and duration or stop time for the message to be displayed.
